(19) United States
(12) Patent Application Publication
(10) Pub. No.: US 2017/0115999 A1
(43) Pub. Date: Apr. 27, 2017

(54) METHOD, SYSTEM, AND NON-TRANSITORY COMPUTER-READABLE RECORDING MEDIUM FOR RECORDING AND REPRODUCING AN OPERATION

(71) Applicant: FUJITSU LIMITED, Kawasaki-shi (JP)

(72) Inventors: Masahito Kobayashi, Arakawa (JP); Momoko Ozaki, Yokohama (JP)

(21) Appl. No.: 15/291,667

(22) Filed: Oct. 12, 2016

(30) Foreign Application Priority Data
Oct. 23, 2015 (JP) 2015-209354

(51) Int. Cl. G06F 9/44; G06F 3/0484

(52) U.S. Cl. CPC G06F 9/4443; G06F 3/04842

(57) ABSTRACT

A non-transitory computer-readable recording medium for a process including obtaining time set to a computer that records an operation, comparing the time with a time difference between first and second clicking, determining an operation type corresponding to the first and second clicking is a double-click when the time difference is shorter than the time, determining that the operation type corresponding to the first and second clicking is a single-click when the time difference is longer than the time, recording information corresponding to the operation, obtaining a time that is set to a computer that reproduces the operation, instructing the second clicking be generated after the first clicking is instructed to be generated when the operation type is the double-click, and instructing the second clicking be generated when the time elapses after the first clicking is instructed to be generated when the operation type is the single-click.

### CROSS-REFERENCE TO RELATED APPLICATIONS

This application is based upon and claims the benefit of priority of the prior Japanese Patent Application No. 2015-209354 filed on Oct. 23, 2015, the entire contents of which are incorporated herein by reference.

### FIELD

The embodiments discussed herein are related to a method, a system, and a non-transitory computer-readable recording medium for recording and reproducing an operation.

### BACKGROUND

Conventionally, there is a known technology of recording the content of an operation performed on a computer and reproducing the recorded content of the operation (see, for example, Japanese Laid-Open Patent Publication No. 2005-63279).

With the operation content recorded by using the conventional method, the operation content cannot be replicated in a case where recorded coordinate information is not included in a screen's display area in which an object (e.g., icon) has been operated. Further, with the operation content recorded by using the conventional method, one cannot identify what operation has been performed on what object for activating a program.

Therefore, with the conventional method, the recorded operation content could not be correctly reproduced, for example, in a case where there is a difference between the setting environment of a display screen used when recording the operation content and the setting environment of a display screen used when reproducing the operation content.

### SUMMARY

According to an aspect of the invention, there is provided a non-transitory computer-readable recording iridium on which a program is recorded for causing a processor to execute a process. The process includes obtaining a first predetermined time that is set to a first computer that records an operation, comparing the first predetermined time with a time difference between a first clicking operation and a second clicking operation, determining that a type of operation corresponding to the first and second clicking operations is a double-click operation when the time difference is shorter than the first predetermined time, determining that the type of operation corresponding to the first and second clicking operations is a single-click operation when the time difference is longer than the first predetermined time, recording operation record information corresponding to the operation, obtaining a second predetermined time that is set to a second computer that reproduces the operation, instructing that the second clicking operation be generated after the first clicking operation is instructed to be generated in a case where the type of the operation included in the operation record information is the double-click operation, and instructing that the second clicking operation be generated when the second predetermined time elapses after the first clicking operation is instructed to be generated in a case where the type of the operation included in the operation record information is the single-click operation.

The object and advantages of the invention will be realized and attained by means of the elements and combinations particularly pointed out in the claims.

It is to be understood that both the foregoing general description and the followed detailed description are exemplary and explanatory and are not restrictive of the invention, as claimed.

### BRIEF DESCRIPTION OF DRAWINGS

FIG. 1 is a schematic diagram for describing the recording and reproduction of an operation content according to an embodiment of the present invention;

FIG. 2 is a first diagram for describing the recording of operation record information by a recording apparatus and the reproduction of operation record information by a reproduction apparatus according to an embodiment of the present invention;

FIG. 3 is a second diagram for describing the recording of operation record information by a recording apparatus and the reproduction of operation record information by a reproduction apparatus according to an embodiment of the present invention;

FIG. 4 is a schematic diagram, illustrating an example of writing operation record information in a case where the operation record information is written without distinguishing a double-click operation and a single-click operation;

FIG. 5 is a schematic diagram illustrating an example of a hardware configuration of a recording apparatus according to an embodiment of the present invention;

FIG. 6 is a functional block diagram of a recording apparatus and a reproduction apparatus according to the first embodiment of the present invention;

FIG. 7 is a first flowchart illustrating the processes of recording operation record information by using a recording unit according to an embodiment of the present invention;

FIG. 8 is a second flowchart illustrating the processes of recording operation record information by using a recording unit according to an embodiment of the present invention;

FIG. 9 is a first flowchart illustrating the processes of reproducing operation record information by using a reproduction unit according to an embodiment of the present invention;

FIG. 10 in a second flowchart illustrating the processes of reproducing operation record information by using a reproduction unit according to an embodiment of the present invention;

FIG. 11 is a third diagram for describing the recording of operation record information by a recording apparatus and the reproduction of operation record information by a reproduction apparatus according to an embodiment of the present invention;

FIG. 12 is a fourth diagram for describing the recording of operation record information by a recording apparatus and the reproduction of operation record information by a reproduction apparatus according to an embodiment of the present invention;

FIG. 13 is a functional block diagram of a recording apparatus and a reproduction apparatus according to the second embodiment of the present invention; and

FIG. 14 is a schematic diagram of a system configuration of a recording/reproduction system according to the third embodiment of the present invention.

### DESCRIPTION OF EMBODIMENTS

### First Embodiment

Next, embodiments of the present invention are described with reference to the accompanying drawings.

In the first embodiment, the content of an operation performed on a computer 100 is recorded as operation record information 200. The computers 300-1, 300-2 read out the recorded operation record information 200 and replicate the recorded operation in the operation record information.

In the first embodiment, the operation that is recorded as the operation record information may be, for example, an operation desired to be repeatedly performed by the computer 100 or an operation desired to be performed by other computers 300-1, 300-2.

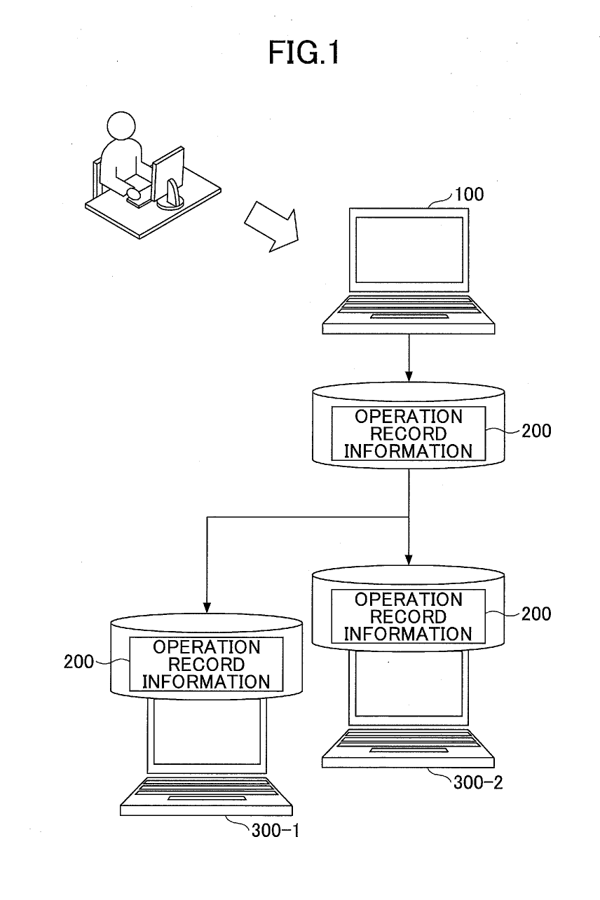

Although FIG. 1 illustrates two computers 300-1, 300-2 as the computers that reproduce the operation record information 200, the number of computers 200 that reproduce the operation record information 200 may be a given number and is not limited to two computers. In the following description, the computers 300-1, 300-2 are collectively referred to as the computer 300 in a case where the computer 300-1 and the computer 300-2 are not distinguished from each other.

In the following description, the computer 100 that records the operation record information (i.e., the content of an operation performed on the computer 100) 200 is hereinafter referred to as “recording apparatus 100”. The computer 300 that reproduces the operation record information 200 is hereinafter referred to as “reproduction apparatus 300”.

In the recording apparatus 100 of the first embodiment, an operation performed on the recording apparatus 100 can be automatically performed by a given number of reproduction apparatuses 300 by recording the operation record information 200. Thus, in a case of, for example, executing an operation of applying the same setting on multiple computers, the operation can be achieved by recording the operation record information 200 of a corresponding operation performed on a single recording apparatus 100 and allowing the operation record information 200 to be reproduced by the multiple computers.

Although independent computers, that is, the recording apparatus 100 and the reproduction apparatus 300 are separately used in the first embodiment, the recording apparatus 100 and the reproduction apparatus 300 may be a single device. In this case, the single device records the operation record information 200 and reproduces the recorded operation record information 200 when, for example, the same operation is desired to be performed multiple times by a single computer.

The operation record information 200 of the first embodiment may be recorded in, for example, an external storage device connected to the recording apparatus 100 or a portable type recording medium connectable to the recording apparatus 100.

Next, the recording of the operation record information 200 by the recording apparatus and the reproduction of the operation record information 200 by the reproduction apparatus 300 according to the first embodiment are described.

As the operation record information 200 to be recorded by the recording apparatus 100 of the first embodiment, the recording apparatus 100 records object identification information identifying an object displayed on a display screen and operation type information indicating the type of operation performed on the identified object. In other words, the operation record information 200 of the first embodiment includes object identification information and operation type information associated with the object identification information.

The reproduction apparatus 300 of the first embodiment Identifies an object to be operated on the display screen of the reproduction apparatus 300 based on the object identification information included in the operation record information 200. Then, based on the operation type information included in the operation record information 200, the reproduction apparatus 300 generates an operation corresponding to the type of operation indicated in the operation type information with respect to the identified object.

In the first embodiment, an object is a component (element) that can be displayed on a screen in a selectable state and subjected to an operation.

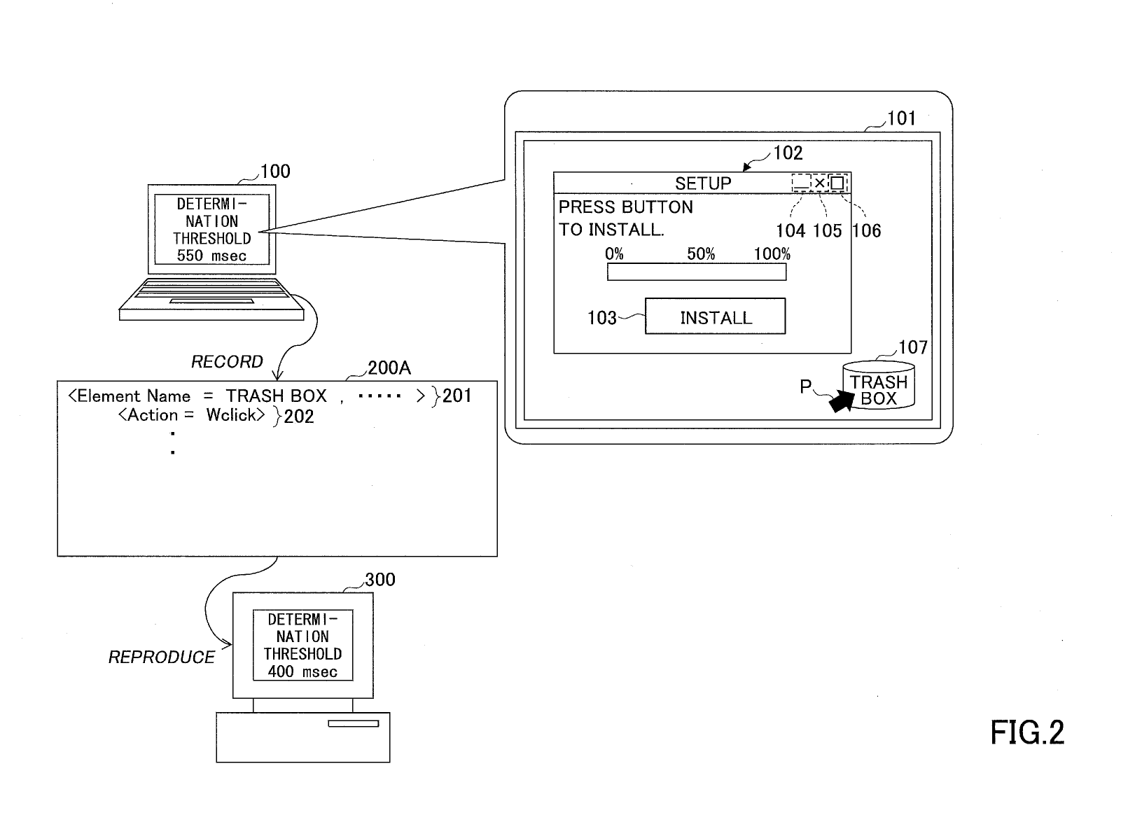

FIG. 2 is a first diagram for describing the recording of operation record information 200 by the recording apparatus 100 and the reproduction of operation record information 200 by a reproduction apparatus 300 according to an embodiment of the present invention.

FIG. 2 illustrates an example where the content of an operation performed on an object displayed on a display screen 101 of the recording apparatus 100 is recorded. The display screen 101 is displayed on a display or the like of the recording apparatus 100.

The display screen 101 is a desktop screen of the recording apparatus 100. The display screen 101 of FIG. 2 is displaying objects 102 to 107. The objects 102 to 107 are objects that can be selected and subjected to an operation.

The object 102 is a window that la started by the activation of a setup application. The object 103 is a display component for requesting a program or the like to be installed.

The object 104 is a display component for requesting the minimization of the window. The object 105 is a display component for requesting the closing of the window. In this embodiment, the request for closing the window is a request for terminating a setup application. The object 106 is a display component for requesting the maximization of the window. The object 107 is one of the icons arranged on the display screen 101. In this embodiment, the object 107 is an icon of a trash box.

The display screen 101 of FIG. 2 illustrates a case where the object 107 is selected with a pointer P and a double-click operation is performed on the selected object 107.

When a double-click operation is performed on the object 107, the recording apparatus 100 of the first embodiment records operation record information 200A including the object identification information 201 identifying the object 107 and the operation type information 202 indicating the double-click operation.

Note that the object identification information 201 of the first embodiment includes at least the name of an object. In addition to the name of the object, the object identification information 201 of the first embodiment may also include, for example, position information indicating the position in which the object is displayed, layer information indicating the layer in which the object belongs in a case assuming that the desktop screen is the highest layer, and time information indicating the time in which an operation is performed on the object.

The reproduction apparatus 300 of the first embodiment reads the operation record information 200A and identifies the object 107 on which the operation is performed based on the object identification information 201. That is, the reproduction apparatus 300 determines that the target operation object 107 is a “trash box”. Further, the reproduction apparatus 300 identifies the operation performed on the object 107 based on the operation type information 202. That is, the reproduction apparatus 300 determines that the operation performed on the object 107 is a double-click operation. Accordingly, the reproduction apparatus 300 generates a double-click operation with respect to the object 107.

Hence, in a case of recording the operation record information 200A with the above-described embodiment, the recording apparatus 100 records operation identification information, that is, information identifying an object on which an operation is performed. Further, in a case of recording the operation record information 200A with the above-described embodiment, the recording apparatus 100 records information indicating the type of operation performed on an object.

Accordingly, in a case of reproducing the operation record information 200A with the above-described embodiment, the reproduction apparatus 300 can replicate the operation performed on an object regardless of the position in which the object is displayed on the display screen. Thus, the accuracy of replicating an operation can be improved.

Further, in a case of reproducing the operation record information 200A with the above-described embodiment, an object and an operation performed on the object can be identified (i.e., determining what operation is performed on what object, even in a case where for example, the setting environment of a display screen used when recording the operation content and the setting environment of a display screen used when reproducing the operation content are different. Thus, versatility can be improved with the above-described embodiment.

Next, a double-click operation is described.

In a case where a clicking operation is consecutively performed two times, the recording apparatus 100 of the first embodiment distinguishes the clicking operation between a single-click operation being performed two times and a double-click operation being performed one time and records the clicking operation according to the distinguishing.

More specifically, the recording apparatus 100 of the first embodiment determines that a double-click operation is performed when the recording apparatus 100 receives a clicking operation for the second time within a predetermined time after receiving a clicking operation for the first time. Accordingly, the recording apparatus 100 records “double click” (W click) as the operation type information. In a case where the recording apparatus 100 does not receive a second clicking operation within the predetermined time after receiving a clicking operation for the first time, the recording apparatus 100 records both the first clicking operation and the second clicking operation as a “click” (single click).

The predetermined time is a threshold for determining whether a clicking operation being performed two times corresponds to a double-click operation being performed once or a single-click operation being performed twice. The predetermined time is included in one of the environment settings of a display screen of a computer. In the following description, the threshold is referred to as “determination threshold”.

In the example of FIG. 2, a determination threshold of 550 ms (milliseconds) is set to the recording apparatus 100. Further, a determination threshold shorter than the determination threshold of the recording apparatus 100, more specifically, 400 ms, is set to the reproduction apparatus 300.

In this case, when the recording apparatus 100 receives the second clicking operation within 550 ms after receiving the first clicking operation, the recording apparatus 100 determines that the type of operation performed on the recording operation 100 is a double-click operation and records the type of operation “double-click operation” in the operation record information 200.

In a case where the operation type information 202 in the operation record information 200 is a double-click operation, the reproduction apparatus 300 refers to the determination threshold that is set to the reproduction apparatus 300 and replicates the double-click operation by generating a first clicking operation and generating a second clicking operation within 400 ms from the first clicking operation.

Hence, in a case where the type of operation in the operation record information 200A is a double-click operation, the reproduction apparatus 300 of the first embodiment generates a second clicking operation within a determination threshold (set to the reproduction apparatus 300) from the generation of the first clicking operation.

Thus, by reproducing the operation record information 200A with the reproduction apparatus 300 according to the first embodiment, the reproduction apparatus 300 can replicate the double-click operation performed on the recording apparatus 100 (being set with a determination threshold different from the determination threshold set to the reproduction apparatus) without erroneously determining that a single-click operation has been performed twice.

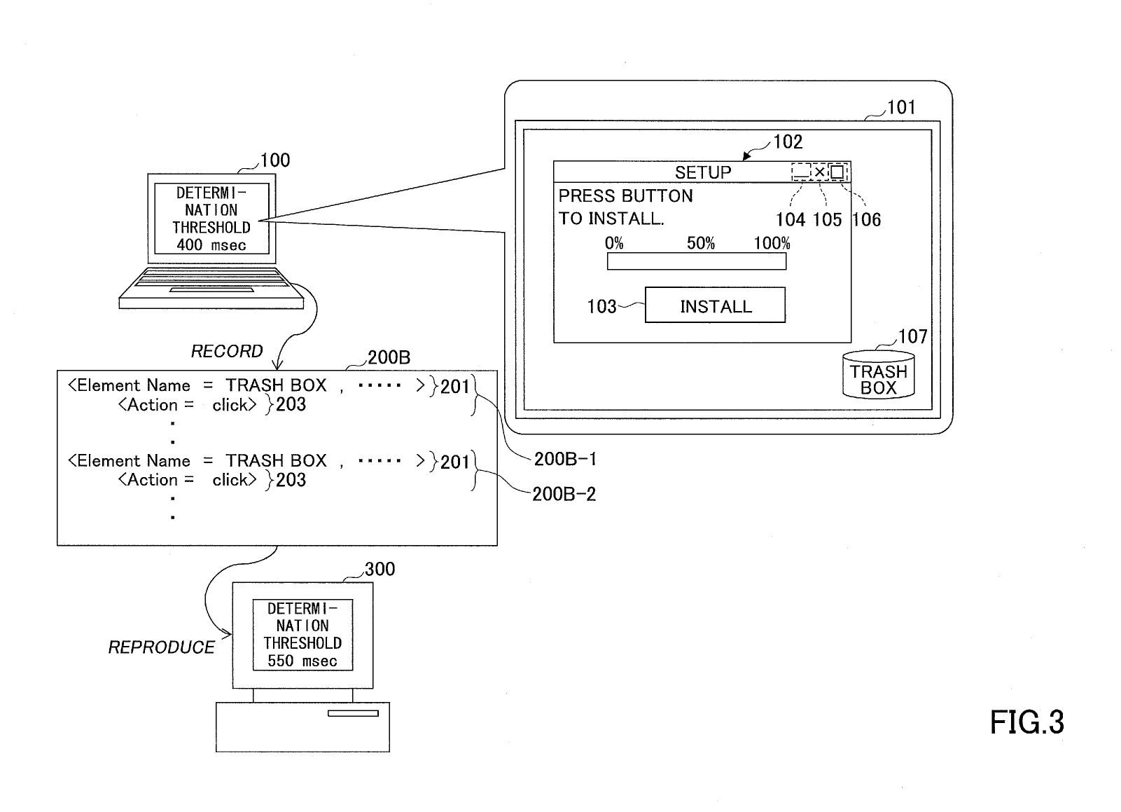

Next, a case where a single-click operation is performed two times on the recording apparatus 100 is described with reference to FIG. 3.

FIG. 3 is a second diagram for describing the recording of operation record information by the recording apparatus 100 and the reproduction of operation record information by the reproduction apparatus 300 according to an embodiment of the present invention.

In the example of FIG. 3, a determination threshold of 400 ms (milliseconds) is set to the recording apparatus 100. Further, a determination threshold longer than the determination threshold of the recording apparatus 100, more specifically, 550 ms is set to the reproduction apparatus 300.

Assuming that a clicking operation is performed at an interval of 500 ms on the recording apparatus 100 of FIG. 3, the recording apparatus determines that the twice-performed clicking operation corresponds to a single-click operation being performed two times. Then, the recording apparatus 100 records the operation type information “click” with respect to each of the clicking operations performed on the recording apparatus 100.

The operation record information 200B of FIG. 3 includes operation information 200B-1 indicating the first single-click operation performed on the object 107 and operation information 200B-2 indicating the second single-click operation performed on the object 107.

Each of the operation information 200B-1, 200B-2 includes object identification information 201 identifying the object 107 and operation type information 203 Indicating the type of operation performed on the object 107.

In other words, the operation record information 200B of FIG. 3 includes two operation information 200B-1 and 200B-2 and indicates that an operation has been performed twice on the recording apparatus 100.

In a case where the operation type information 203 of the operation record information 200B is a single-click operation, the reproduction apparatus 300 of the first embodiment refers to the determination threshold set to the reproduction apparatus 300, generates a first clicking operation, and generates a second clicking operation after 550 ms has elapsed from the generation of the first clicking operation. Accordingly, the twice-performed single-click operation can be replicated by the reproduction apparatus 300.

Accordingly, in a case where the type of operation in the operation record information 200B is the single-click operation performed twice, the reproduction apparatus 300 of the first embodiment generates a second clicking operation after the determination threshold set to the reproduction apparatus 300 has elapsed from the generation of the first clicking operation.

Hence, by reproducing the operation record information 200B in the manner described above, the reproduction apparatus 300 of the first embodiment can replicate the single-click operation performed twice on the recording apparatus 100 (being set with a determination threshold different from the determination threshold set to the reproduction apparatus) without erroneously determining that a double-click operation has been performed.

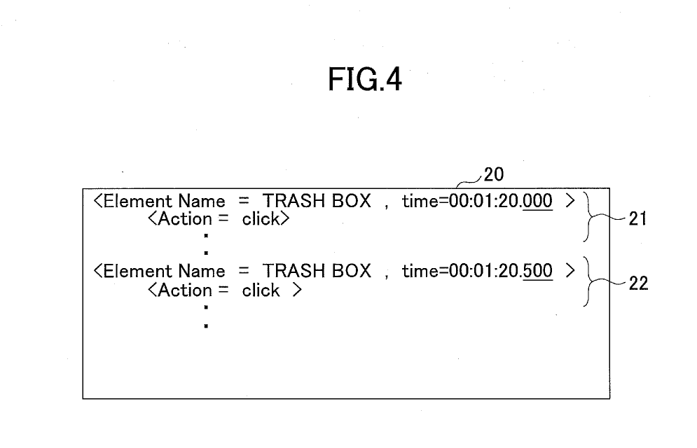

Next, a case of recording operation record information without distinguishing between the double-click operation and the single-click operation is described with reference to FIG. 4.

FIG. 4 is a schematic diagram illustrating an example of writing operation record information in a case where the operation record information is written without distinguishing between a double-click operation and a single-click operation.

In a case where the recording apparatus 100 receives a clicking operation twice, the recording apparatus 100 records the twice-performed clicking operations in the form of operation record information 20 that includes each of the clicking operations associated with the time in which the recording apparatus 100 has received the clicking operations.

The operation record information 20 of FIG. 4 includes operation information 21 and operation information 22. The operation information 21 indicates a clicking operation performed on the object 107 on 12 AM, 1 minute, and 20 seconds. The operation terminal 22 indicates a clicking operation performed on the object 107 on 12 AM, 1 minute, and 20.5 seconds.

In other words, the operation record information 20 indicates that a clicking operation has been performed twice on the same object at an interval of 500 ms.

Assuming a case where the determination threshold of the recording apparatus 100 is 550 ms whereas the determination threshold of the reproduction apparatus 300 is 400 ms, the operation record information 20 is written to indicate that a double-click operation has been performed on the recording apparatus 100.

In this case, if the reproduction apparatus 300 reproduces a clicking operation in accordance with the interval indicated in the operation record information 20 (i.e., 500 ms), the reproduction apparatus 300 would not generate a double-click operation but would instead generate a single-click operation twice because the interval between the twice-performed click operations is longer than the determination threshold of the reproduction apparatus 300. Thus, the double-click operation recorded in the operation record information 20 cannot be replicated by the reproduction apparatus 300.

Next, assuming a case where the determination threshold of the recording apparatus 100 is 400 ms whereas the determination threshold of the reproduction apparatus 300 is 550 ms, the operation record information 20 is written to indicate that a single-click operation has been performed on the recording apparatus 100.

In this case, if the reproduction apparatus 300 reproduces a clicking operation in accordance with the interval indicated in the operation record information 20 (i.e., 500 ms), the reproduction apparatus 300 would not generate a single-click operation but would instead generate a double-click operation because the interval between the twice-performed clicking operations is less than or equal to the determination threshold of the reproduction apparatus 300. Thus, the twice-performed single-click operations that are recorded in the operation record information 20 cannot be replicated by the reproduction apparatus 300.

However, according to the first embodiment, in a case where a clicking operation is performed twice on the recording apparatus 100, the recording apparatus 100 determines whether the twice-performed clicking operations correspond to a double-click operation or single-click operations, and records the determination results. Accordingly, with the first embodiment, the reproduction apparatus 300 can replicate the operations performed on the recording apparatus 100 even in a case where the determination threshold set to the recording apparatus 100 and the determination threshold set to the reproduction apparatus 300 are different.

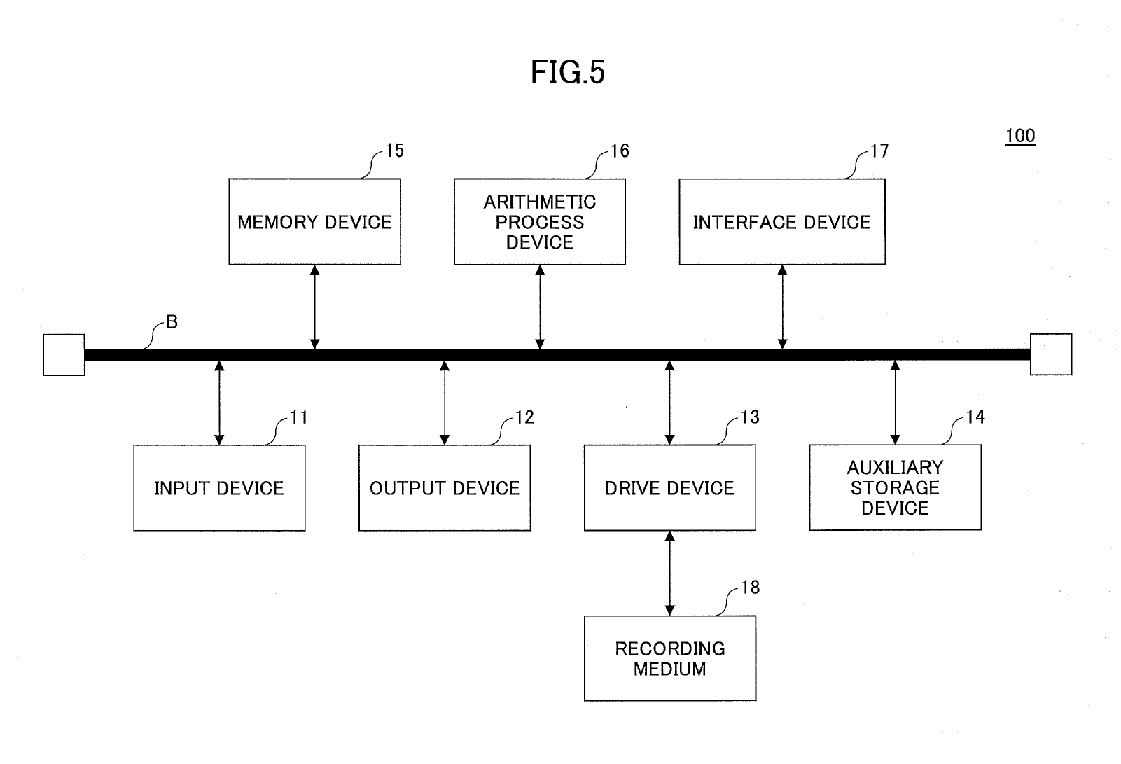

Next, the hardware configurations of the recording apparatus 100 and the reproduction apparatus 300 of the first embodiment are described with reference to FIG. 5. Because the hardware configuration of the recording apparatus 100 and the hardware configuration of the reproduction apparatus 300 are the same, only the hardware configuration of the recording apparatus 100 is depicted in FIG. 5. The description of the hardware configuration of the reproduction apparatus 300 is omitted.

FIG. 5 is a schematic diagram illustrating an example of the hardware configuration of the recording apparatus 100. The recording apparatus 100 of the first embodiment includes an input device 11, an output device 12, a drive device 13, an auxiliary storage device 14, a memory device 15, an arithmetic process device 16, and an interface device 17 that are connected to each other via a bus B.

The input device 11 may be, for example, a keyboard or a mouse for inputting various signals. The output device 12 may be, for example, a display device for displaying various windows and data. The interface device 17 may be, for example, a modem, a LAN card for connecting the recording apparatus 100 to a network.

An operation recording/reproduction program is at least a portion of the various programs that control the recording apparatus 100. The operation recording/reproduction program may be provided by way of distribution of a non-transitory computer-readable recording medium 18 on which the operation recording/reproduction program is recorded. The operation recording/reproduction program may also be downloaded from a network. The non-transitory computer-readable recording medium 18 on which the operation recording/reproduction program is recorded may be various types of recording media. For example, the is recorded may be a recording medium that optically, electrically, or magnetically records information (e.g., CD-ROM, flexible disk, Magneto-optical disk). The non-transitory computer-readable recording medium 13 may also be a semiconductor memory that electrically records information (e.g., ROM, flash memory).

Further, the operation recording/reproduction program recorded on the recording medium 18 may be installed in the auxiliary storage device 14 by mounting the recording medium 18 on the drive device 13 and loading the operation recording/reproduction program to the auxiliary storage device 14 via the drive device 13. Alternatively, the operation recording/reproduction program downloaded from the network may be installed in the auxiliary storage device 14 via the interface device 17.

The auxiliary storage device 14 stores the installed operation recording/reproduction program along with other files and data. The memory device 15 reads the operation recording/reproduction program from the auxiliary storage device 14 upon activation of a computer or the like and stores the operation recording/reproduction program. Then, the arithmetic process device 16 implements the below-described various processes according to the operation recording/reproduction program stored in the memory device 15.

The recording apparatus 100 of the first embodiment may be, for example, a tablet-type computer. In this case, the recording apparatus 100 may include a display operation device having a display function (e.g., touch panel) instead of the input device 11 and the output device 12.

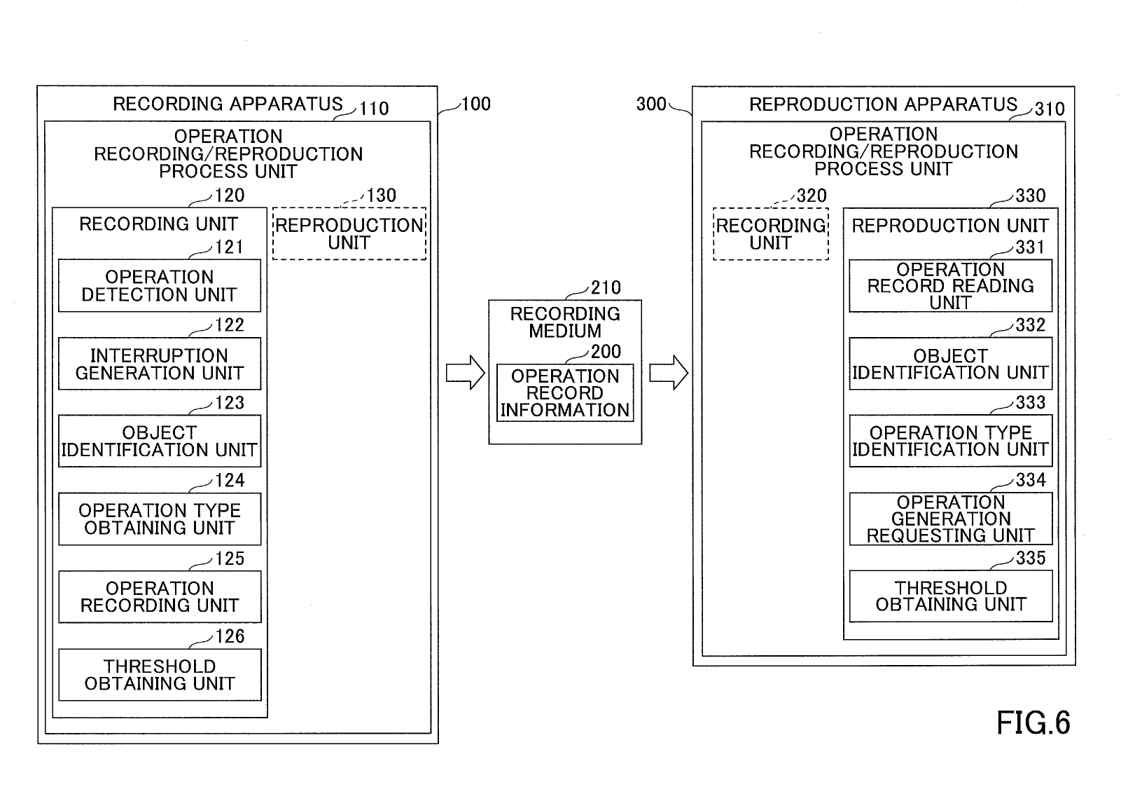

Next, the functions of the recording apparatus 100 and the reproduction apparatus 300 of the first embodiment are described with reference to FIG. 6.

FIG. 6 is a functional block diagram of the recording apparatus 100 and the reproduction apparatus 300 according to the first embodiment of the present invention. The recording apparatus 100 of the first embodiment includes an operation recording/reproduction process unit 110. Further, the reproduction apparatus 300 of the first embodiment includes an operation recording/reproduction process unit 310.

The operation recording/reproduction process unit 110 of the first embodiment is implemented by causing the arithmetic process device 16 to execute the operation recording/reproduction program installed in the recording apparatus 100.

Further, the operation recording/reproduction process unit 310 of the first embodiment is implemented by causing the arithmetic process device of the reproduction apparatus 300 to execute the operation recording/reproduction program installed in the reproduction apparatus 300.

The operation recording/reproduction program installed in each of the recording apparatus 100 and the reproduction apparatus 300 may be the same program.

In the recording apparatus 100, the recording unit 120 is implemented by executing a recording program included in the operation recording/reproduction program, so that a computer such as the arithmetic process unit 16 executes the functions of the recording apparatus 100.

Further, in the reproduction apparatus 300, the reproduction unit 330 is implemented by executing a reproduction program included in the operation recording/reproduction program, so that a computer or a processor of the reproduction apparatus 300 executes the functions of the reproduction apparatus 300.

The operation recording/reproduction process unit of the recording apparatus 100 of the first embodiment includes the recording unit 120 and a reproduction unit 130.

In the recording apparatus 100 of the first embodiment, the recording unit 120 is implemented as described above. The recording unit 120 of the first embodiment includes an operation detection unit 121, an interruption generation unit 122, an object identification unit 123, an operation type obtaining unit 124, an operation recording unit 125, and a threshold obtaining unit 126.

The operation detection unit 121 detects an operation performed on the recording apparatus 100. More specifically, the operation detection unit 121 of the first embodiment receives a report indicating that the OS (Operating System) installed in the recording apparatus 100 has detected a clicking operation, a dragging operation, or a drop operation and reports the detection of the operation to the interruption generation unit 122.

According to the first embodiment, in a case where a downward and an upward movement of a mouse button is detected on the same coordinates of a screen, this operation of the mouse button is determined to be a clicking operation. Further, in a case where the coordinates pointed by a pointer is moved after the upward and downward movement of the mouse button, this operation of the mouse button is determined to be a dragging operation. Further, in a case where an upward movement of the mouse button is detected after the coordinates pointed by the pointer is moved, this operation of the mouse button is determined to be a dropping operation.

When the operation detection unit 121 detects a target operation (an operation to be detected), the interruption generation unit 122 of the first embodiment generates an interruption with respect to the OS installed in the recording apparatus 100 and requests that the content of the target operation be recorded.

When the interruption is generated, the object identification unit 123 of the first embodiment obtains object identification information that identifies the object being pointed by the pointer.

More specifically, the object identification unit 123 obtains coordinate information of the position being pointed on the screen by the pointer, sends the obtained coordinate information to the OS, and obtains object identification information of the object corresponding to the coordinate information from the OS.

The operation type obtaining unit 124 of the first embodiment obtains information indicating the type of operation detected by the operation detection unit 121.

The operation recording unit 125 of the first embodiment associates the object identification information obtained from the object identification unit 123 with the operation type information obtained from the operation type obtaining unit and records the associated object identification information and the operation type information as the operation record information 200.

Further, in a case where the clicking operation is performed two times, the operation record unit 125 of the first embodiment determines whether the twice-performed clicking operations correspond to a double-click operation or a single-click operation performed two times, and records the operation record information 200 according to the determination results.

The operation record information 200 is recorded in, for example, a portable-type recording medium 210. As long as the recording medium 210 can be read by the reproduction apparatus 300, the type of recording medium 210 is not limited in particular.

The operation recording unit 125 of the first embodiment terminates the recording process when the operation recording unit 125 receives an instruction to terminate the recording process.

The threshold obtaining unit 126 of the first embodiment obtains a determination threshold that is set to the recording apparatus 100.

The functional configuration of the reproduction unit 130 of the recording apparatus 100 of the first embodiment is the same as the functional configuration of the below-described reproduction unit 330 of the reproduction apparatus 300.

The operation reproduction unit 310 of the reproduction apparatus 300 of the first embodiment includes a recording unit 320 and a reproduction unit 330.

In the recording apparatus 100 of the first embodiment, the recording unit 120 is implemented as described above. The recording unit 120 of the first embodiment includes an operation detection unit 121, an interruption generation unit 122, an object identification unit 123, an operation type obtaining unit 124, an operation recording unit 125, and a threshold obtaining unit 126.

In the reproduction apparatus 300 of the first embodiment, the reproduction unit 330 is implemented as described above. The reproduction unit 330 of the first embodiment includes an operation record reading unit 331, an object identification unit 332, an operation type identification unit 333, on operation generation requesting unit 334, and a threshold obtaining unit 335.

The operation record reading unit 331 of the first embodiment reads the operation record information 200 stored in the recording medium 210.

The object identification unit 332 of the first embodiment identifies an object to be operated (target operation object) in the display screen of the reproduction apparatus 300 based on the object identification information included in the operation record information 200. The operation type identification unit 333 identifies the type of operation to be performed on the identified object based on the operation type information included in the operation record information 200.

The operation generation requesting unit 334 of the first embodiment requests the OS installed In the reproduction apparatus 300 to generate the identified operation with respect to the target operation object.

By requesting the OS to generate the identified operation, the requested operation is generated in the reproduction apparatus 300 by way of the function of the OS. Accordingly, the content of the operation recorded in the operation record information 200 is replicated in the reproduction apparatus 300.

The threshold obtaining unit 335 of the first embodiment obtains the determination threshold that is set to the reproduction apparatus 300.

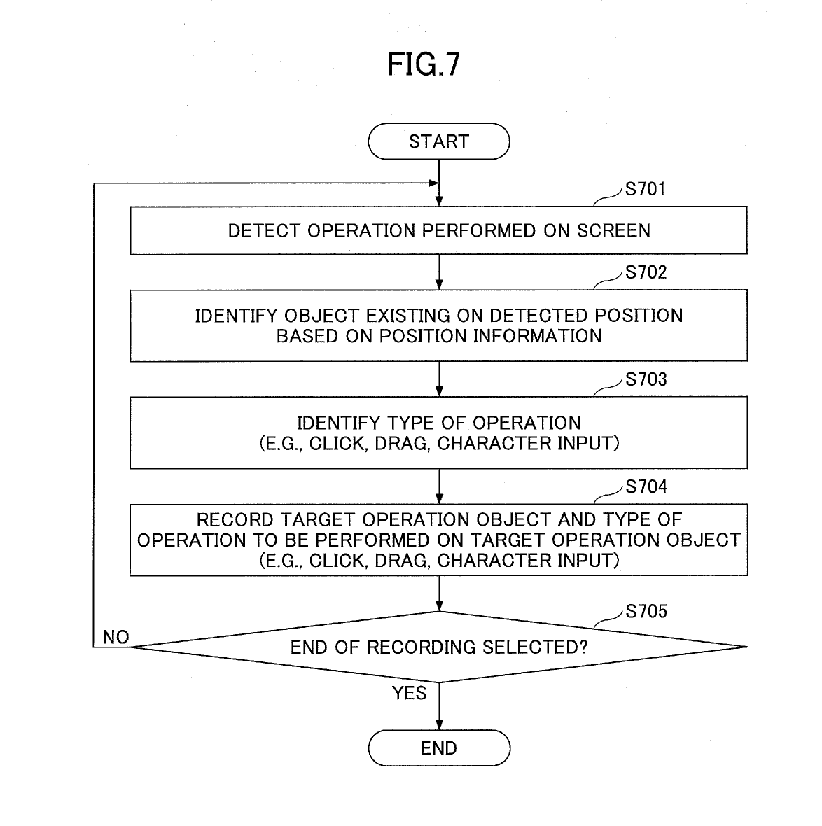

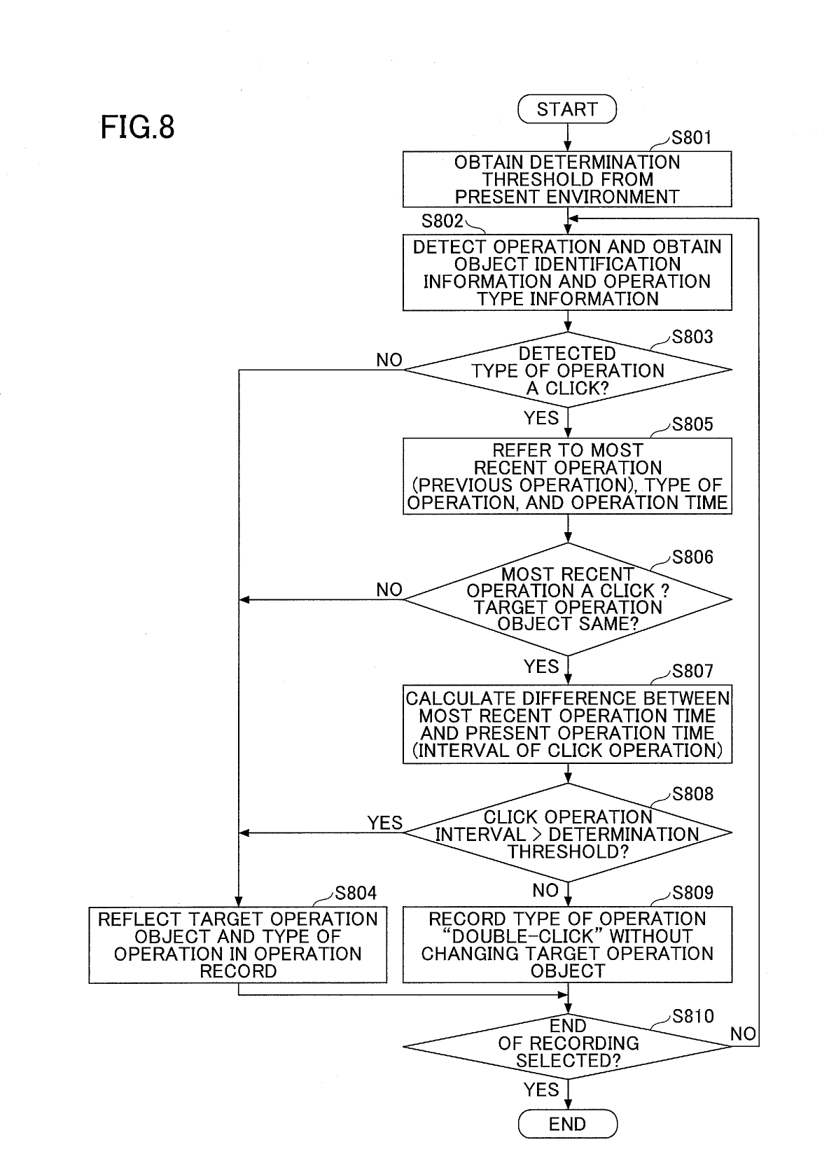

Next, the processes of recording the operation record information 200 by using the recording apparatus 100 of the first embodiment is described with reference to FIGS. 7 and 8.

FIG. 7 is a first flowchart illustrating the processes of recording the operation record information 200 by using the recording unit 120 according to the first embodiment.

In the recording apparatus 100 of the first embodiment, the operation detection unit 121 of the recording unit 120 detects an operation performed on the display screen of the recording apparatus 100 (Step S701). More specifically, the operation detection unit 121 receives a report notifying the detection of an operation from the OS of the recording apparatus 100.

Then, the interruption generation unit 122 of the recording unit 120 generates an interruption with respect to the OS of the recording apparatus 100 when the operation is detected. Thereby, the recording process is started. Then, the object identification unit 123 identifies the object to be operated (Step S702).

More specifically, the object identification unit 123 obtains coordinate information indicating the position of a pointer from the OS at the same time of the detection of the operation and sends the coordinate information to the OS. Then, the object identification unit 123 obtains object identification information identifying the object located at the position indicated in the coordinate information by way of the function of the OS (e.g., Windows (registered trademark)).

Then, the operation type obtaining unit 124 of the recording unit 120 obtains operation type information indicating the type of the detected operation and identifies the type of the detected operation (Step S703). Note that the operation type information may be obtained from the OS, for example, when the operation detection unit 121 detects an operation.

Then, the operation recording unit 125 of the recording unit 120 records the object identification information and the operation type information associated with the object identification information as the operation record information (Step S704).

Then, the operation recording unit 125 of the recording unit 120 determines whether an instruction to terminate the recording process has been received (Step S705). In a case where the instruction to terminate the recording process has not been received, the recording unit 120 returns to the process of Step S701. In a case where the instruction is received in Step S705, the recording unit 120 terminates the recording of the operation record information 200.

Next, the processes performed by the recording unit 120 of the first embodiment is described in further detail with reference to FIG. 8.

FIG. 8 is a second flowchart illustrating the processes of recording operation record information by using the recording unit 120 of the first embodiment.

The processes in Steps S801 to S809 of FIG. 8 illustrate details of the processes in Step S701 to S704 of FIG. 7.

The threshold obtaining unit 126 of the recording unit 120 of the first embodiment obtains the determination threshold that is set to the recording apparatus 100 (Step S801). Then, the operation detection unit 121 of the recording unit 120 detects an operation performed in the display screen of the recording apparatus 100. Then, the object identification unit 123 obtains the object identification information identifying the object that is operated, and the operation type obtaining unit 124 obtains the operation type information indicating the type of operation (Step S802).

Then, the operation recording unit 125 determines whether the type of operation indicated in the obtained operation type information is a clicking operation (Step S803).

In a case where the operation recording unit 125 determines that the detected operation is not a clicking operation (No in Step S803), the operation recording unit 125 records (reflects) the target operation object in association with the type of the operation in the operation record information 200 (Step S804) and proceeds to Step S810. More specifically, the operation recording unit associates the object identification information of the target operation object with the operation type information and adds (records) the associated information in the operation record information 200. Further, in a case where the type of the detected operation is a clicking operation, the detected time of the clicking operation is temporarily recorded in, for example, a storage area of the recording apparatus 100.

In a case where the operation recording unit 125 determines that the detected operation is a clicking operation (Yes in Step S803), the operation recording unit 125 refers to each of the target operation object, the type of operation, and the time of the operation that are recorded in the operation record information 200 of a most recent clicking operation (Step S805).

Then, the operation recording unit 125 determines whether certain conditions are satisfied. Mere specifically, the operation recording unit 125 determines whether the type of the operation is a clicking operation and whether the target operation object is the same as the object identified in Step S802 (Step S806).

In a case where the conditions of Step S806 are not satisfied (No in Step S806), the operation recording unit 125 proceeds to Step S804.

In a case where the conditions of Step S806 are satisfied (Yes in Step S806), the operation recording unit 125 obtains the difference between the time of the operation detected in Step S802 and the time of the detection of a most recent operation (Step S807). That is, the operation recording unit 325 obtains the interval between the clicking operation of the first time (first clicking operation) and the clicking operation of the second time (second clicking operation).

Then, the operation recording unit 125 determines whether the interval between the first clicking operation and the second clicking operation is greater than the determination threshold obtained in Step S801 (Step S808).

In a case where the interval between the first clicking operation and the second clicking operation is less than or equal to the determined threshold (No in Step S808), the operation recording unit 125 reflects the determination results to the operation record by changing the operation type information of the most recent operation record information 200 from “single-click operation” to “double-click operation” without changing the object identification information (Step S809).

Then, the operation recording unit 125 determines whether an instruction to terminate the recording process has been received (Step S810). In a case where the instruction to terminate the recording process has net been received (No in Step S810), the recording unit 120 returns to Step S802.

In a case where the instruction to terminate the recording process has been received (Yes in Step S810), the recording unit 120 terminates the process of recording the content of the operations performed on the recording apparatus 100.

Hence, according to the first embodiment, even in a case where a clicking operation is consecutively performed two times, the clicking operation can be distinguished between a single-click operation and a double-click operation and recorded as a single-click operation or a double-click operation.

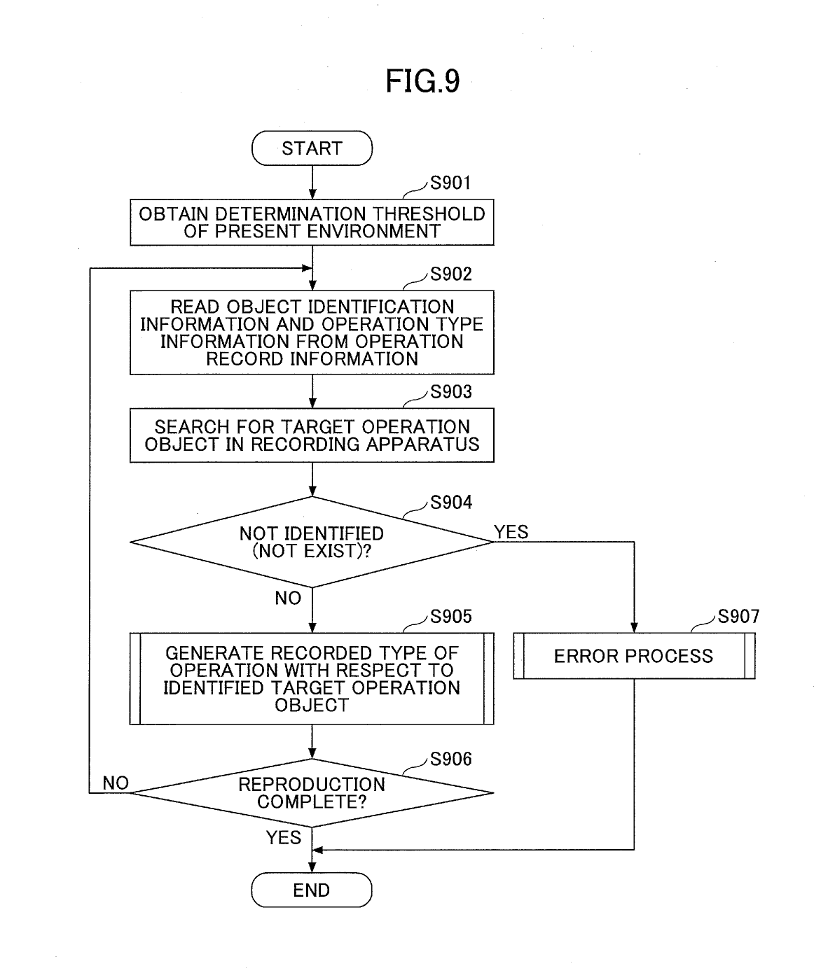

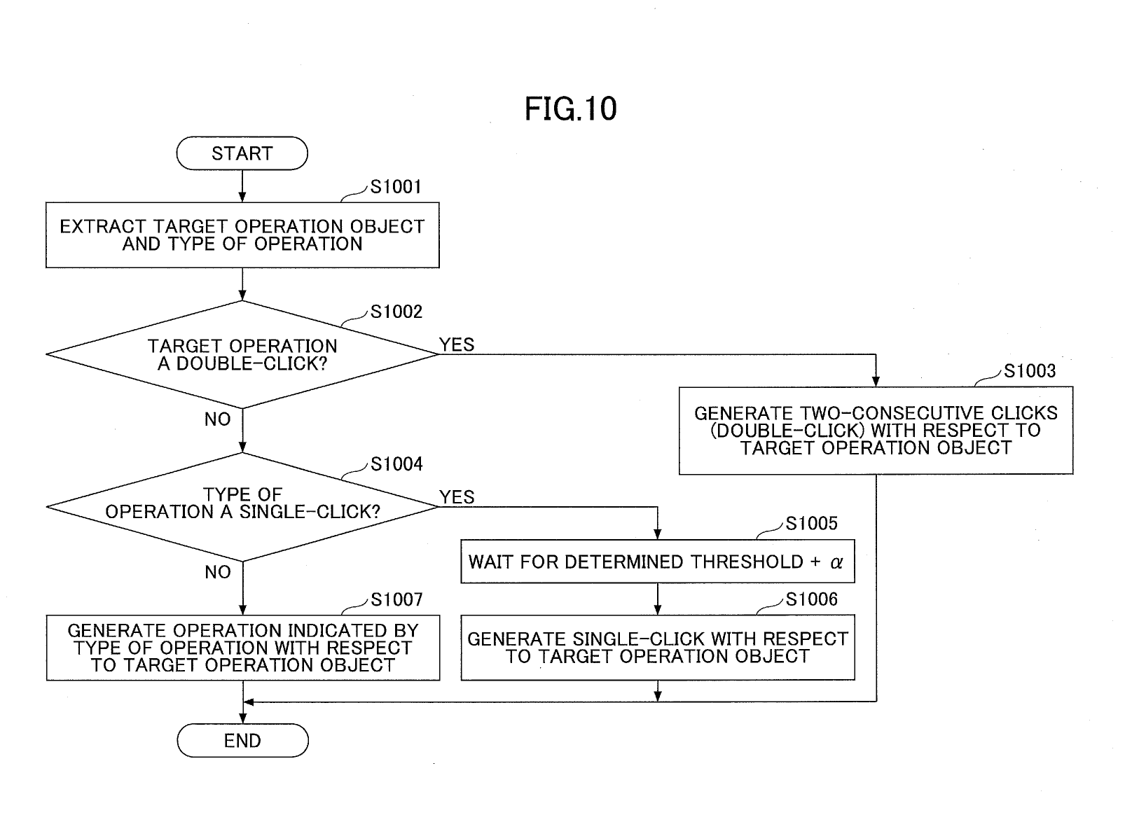

Next, the processes of reproducing operation record information 200 by using the reproduction apparatus 300 of the first embodiment are described with reference to FIGS. 9 and 10.

FIG. 9 is a first flowchart illustrating the processes of reproducing operation record information 200 by using the reproduction unit 330 according to the first embodiment.

In the reproduction apparatus 300 of the first embodiment, the reproduction unit 330 obtains a determination threshold that is set to the reproduction apparatus 300 (Step S901). Then, the operation record reading unit 331 of the reproduction unit 330 obtains the object identification information and the operation type information by reading the operation record information 200 including the object identification information and the operation type information (Step S902).

Then, the object identification unit 332 of the reproduction unit 330 searches for a target operation object in the reproduction apparatus 300 based on the obtained object identification Information (Step S903).

Then, the reproduction unit 330 determines whether the target operation object has been identified (Step S904). In a case where the target operation object is not identified (No in Step S904), the reproduction unit 330 executes an error process and terminates the reproduction process (Stop S907).

The error process of the first embodiment is described as follows.

The case where the target operation object cannot be identified indicates that the target operation object is not displayed on the display screen of the reproduction apparatus 300. This case suggests a possibility that the operation record information is not correctly replicated. Therefore, the reproduction unit 330 of the first embodiment interrupts the reproduction process when the target operation object cannot be identified.

By interrupting the reproduction process, the recording apparatus 300 of the first embodiment interrupts the generation of an operation at a timing when the replication of the operation record information 200 has failed. Therefore, the time in which the failure of the replication of the operation record information has occurred can be determined based on the status of the display screen of the reproduction apparatus 300.

In the first embodiment, the user may be allowed to recover the failure, so that the reproduction apparatus 300 can resume the reproduction of the operation record information to continue the reproduction process from where the reproduction unit 330 had previously left off, that is, continue from the state of the interruption of the reproduction process.

In a case where the target operation object is identified (No in Step S904), the operation type obtaining unit 333 of the reproduction unit 330 obtains the operation type information corresponding to the identified object and generates a corresponding operation (Step S905). Details of the process of Step S905 by the operation generation requesting unit 334 is described below.

Then, the reproduction unit 330 determines whether the replication of all of the operations included in the operation record information 200 is completed (Step S906). In a case where the replication is not completed (No in Step S906), the reproduction unit 330 returns to Step S902. In a case where the replication is completed (Yes in Step S906), the reproduction unit 330 terminates the reproduction process.

Next, the processes of the operation generation unit 334 are described with reference to FIG. 10. FIG. 10 is a second flowchart illustrating the processes of reproducing operation record information by using the reproduction unit 330 according to the first embodiment. The processes depicted in FIG. 10 illustrate the process of Step S905 of FIG. 9 in detail.

The operation generation requesting unit 334 of the first embodiment extracts a target operation object and the type of operation (Step S1001). Then, the operation generation requesting unit 334 determines whether the type of the operation is a double-click operation (Step S1002).

In a case where the type of the operation is a double-click operation (Yes in Step S1002), the operation generation requesting unit 334 requests the OS of the reproduction apparatus 300 to generate a double-click operation with respect to the target operation object (Step S1003) and terminates the processes of FIG. 10.

In a case where the type of the operation is not a double-click operation (No in Step S1002), the operation generation requesting unit 334 determines whether the type of the operation is a single-click operation (Step S1004).

In a case where the type of the operation is a single-click operation (Yes in Step S1004), the operation generation requesting unit 334 waits for the period of the determination threshold to elapse (Step S1005). Then, the operation generation requesting unit 334 requests the OS of the reproduction apparatus 300 to generate a single-click operation with respect to the target operation object (Step S1006) and terminates the processes of FIG. 10.

Hence, in a case where the type of an operation is a clicking operation, the operation generation requesting unit 334 of the first embodiment requests the generation of a clicking operation at a timing in which the period of the determination threshold elapses after the generation of a most recent operation is requested. By requesting the generation of a clicking operation at such a timing, the clicking operation can be replicated regardless of whether the most recent operation is a clicking operation.

In a case where the type of operation is not a single-click operation (No in Stop S1004), the operation generation requesting unit 334 requests the generation of the operation indicated by the operation type information with respect to the target operation object (Step S1007) and terminates the processes of FIG. 10.

Hence, according to the first embodiment, in a case of recording the operation record information 200 for replicating a consecutively performed clicking operation, the clicking operation can be distinguished between a single-click operation end a double-click operation and recorded as a single-click operation or a double-click operation. Therefore, with the reproduction apparatus of the first embodiment, consecutive clicking operations can be prevented from erroneously recognized as a single-click operation or a double-click operation. Thereby, the accuracy of replicating an operation can be improved.

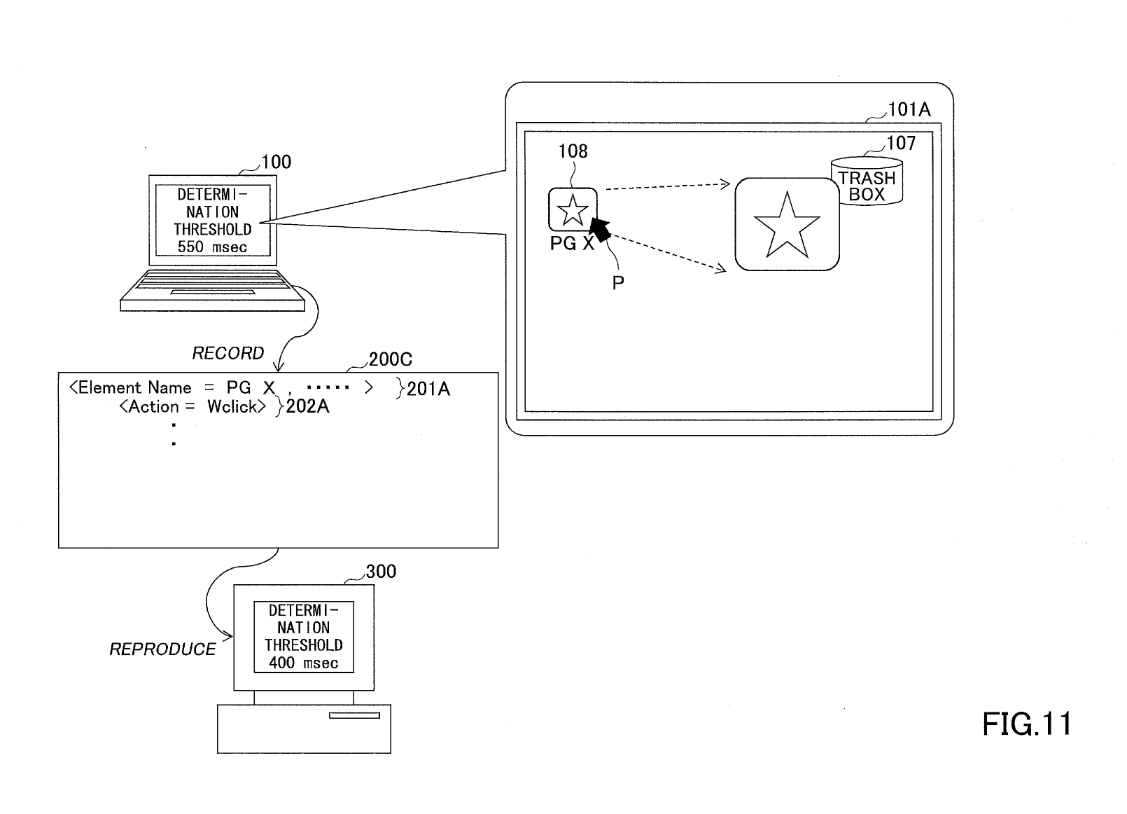

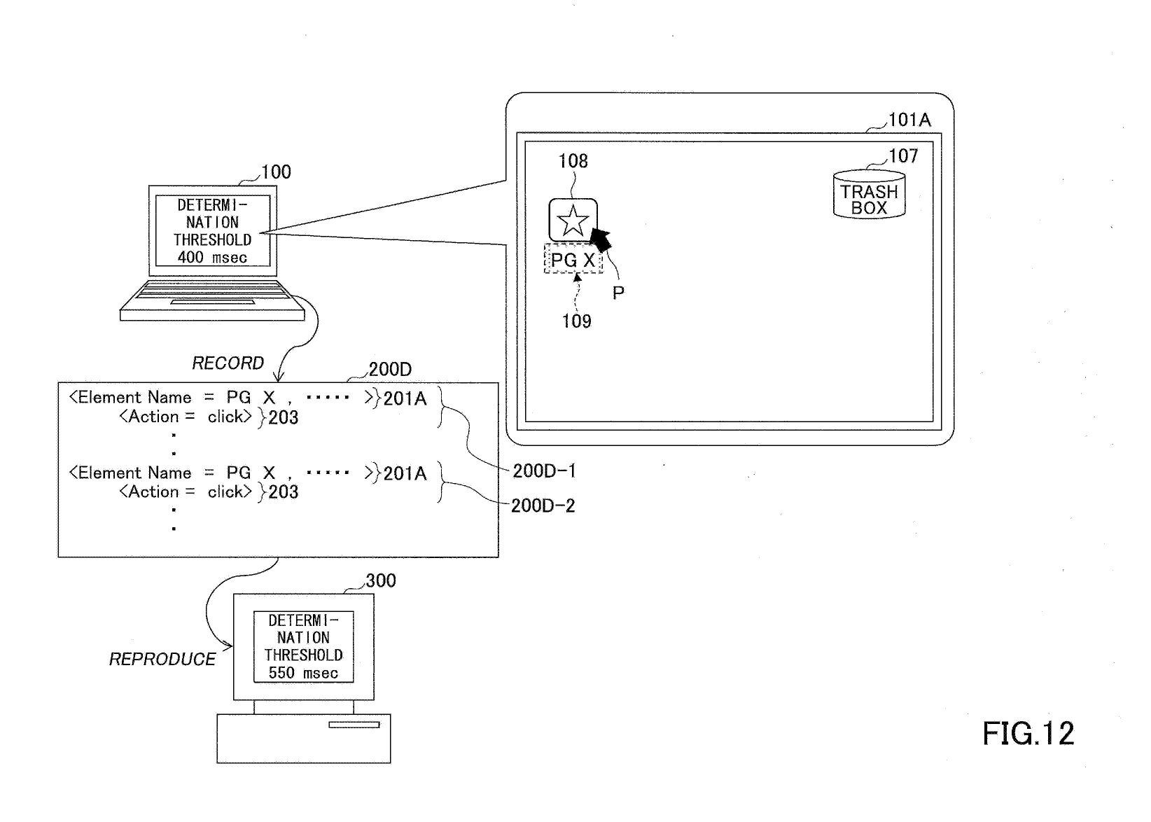

Next, a case of replicating multiple consecutive clicking operations is described with reference to FIGS. 11 and 12.

FIG. 11 is a third diagram for describing the recording of operation record information by the recording apparatus 100 and the reproduction of operation record information by the reproduction apparatus 300 according to the first embodiment.

In the example illustrated in FIG. 11, the determination threshold of the recording apparatus 100 is set to 550 ms whereas the determination threshold of the reproduction apparatus 300 is set to 400 ms. The display screen 101A depicted in FIG. 11 illustrates a case where an object 108 is selected by the pointer P and a double-click operation is performed on the object 108.

When a double-click operation is performed on the object 108, the recording apparatus 100 of the first embodiment records operation record information 200C. The operation record information 200C includes object identification information 201A that identifies the object 108 and operation typo information 202A that indicates the double-click operation.

The object 108 is an icon of an application PGX. When the double-click operator is performed on the object 108, the recording apparatus 100 activates the application.

The reproduction apparatus 300 of the first embodiment reads the operation record information 200C and identifies the target operation object 108 based on the object identification information 201A included in the read operation record information 200C. Further, the reproduction apparatus 300 identifies the operation performed on the object 108 (in this case, a double-click operation) based on the operation type information 202A included in the read operation record information 200C. Accordingly, the reproduction apparatus 300 generates a double-click operation with respect to the object 108. More specifically, the reproduction apparatus 300 generates clicking operations two times, so that the interval of the two-time clicking operations is within 400 ms.

Thus, in the example illustrated in FIG. 11, the reproduction apparatus 300 can replicate the process of activating the application PGX performed by the recording apparatus 100.

FIG. 12 is a fourth diagram for describing the recording of operation record information by the recording apparatus 100 and the reproduction of operation record information by the reproduction apparatus 300 according to the first embodiment.

In the example illustrated in FIG. 12, the determination threshold of the recording apparatus 100 is set to 400 ms whereas the determination threshold of the reproduction apparatus 300 is set to 550 ms.

The display screen 101A depicted in FIG. 12 illustrates a case where an object 108 is selected by the pointer P and a single-click operation is consecutively performed twice on the object 108.

When a single-click operation is performed on the object 108, the recording apparatus 100 of the first embodiment records the operation record information 200D including the object identification information 201A that identifies the object 108 and the operation type information 203 that indicates the clicking operation. The object identification information 201A and the operation type information 203 are stored in association with each other in the operation record information 200D.

The operation record information 200D of FIG. 12 includes operation information 200D-1 indicating a single-click operation of the first time with respect to the object 108 and operation information 200D-1 indicating a single-click operation of the second time with respect to the object 108.

The object 108 is an icon of an application PG X. Accordingly, the recording apparatus 100 selects the object 108 on the display screen 101A in response to the clicking operation performed on the object 108 for the first time. Then, the recording apparatus 100 sets a display column 109 indicating the name of the object 108 into a state that can be edited in response to the clicking operation performed on the object 108 for the second time.

The reproduction apparatus 300 of the first embodiment reads the operation record information 200D and identifies the target operation object 108 according to the object identification information 201A. Further, the reproduction apparatus 300 determines (identifies) that the operations performed on the object 108 are clicking operations that have been performed twice according to the operation type information 203. Therefore, the recording apparatus generates the clicking operation of the first time with respect to the object 108 and replicates the operation of selecting the object 108 displayed on the display screen of the reproduction apparatus 300. Then, the reproduction apparatus 300 generates the clicking operation of the second time with respect to the object 108 and sets the display column 109 indicating the name of the object 108 into a state that can be edited.

More specifically, the reproduction apparatus 300 generates the clicking operation of the second time after generating the clicking operation of the first time. The clicking operation of the second time is generated after an interval longer than 550 ms elapses from the eliciting operation of the first time.

Hence, the recording apparatus of the first embodiment can distinguish a double-click operation from single-click operations performed multiple times and record the operation(s) based on the distinguishing. The reproduction apparatus 300 can replicate recorded operation record information 200 by referring to the determination threshold that is set to the reproduction apparatus itself 300. Hence, with the above-described first embodiment, even in a case where the environment of the display screen during the recording of the content of an operation is different from the environment of the display screen during the reproduction of the content of the operation, the recorded content of the operation can be replicated. Thus, the accuracy of replicating an operation can be Improved.

### Second Embodiment

Next, the second embodiment of the present invention is described with reference to the accompanying drawings. The second embodiment is different from the first embodiment in that a single computer is used to implement the recording unit and the reproduction unit. Therefore, other than the difference between the first embodiment and the second embodiment, like functions (functional units) and components are denoted with like reference numerals of the first embodiment and are not further described.

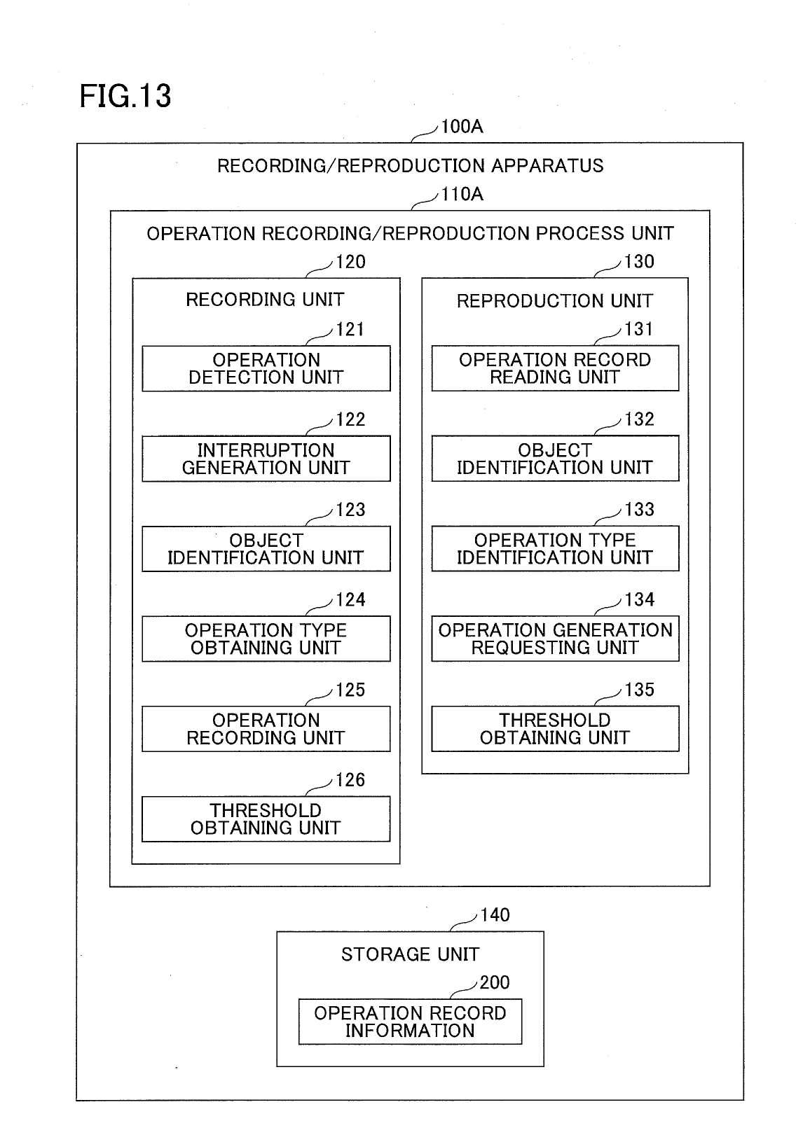

FIG. 13 is a functional block diagram of a recording/reproduction apparatus 100A according to the second embodiment of the present invention. The recording/reproduction apparatus 100A includes an operation recording/reproduction operation process unit 110A.

The operation recording/reproduction operation process unit 110A includes the recording unit 120 and the reproduction unit 130. The reproduction unit 130 includes an operation record reading unit 131, an object identification unit 132, on operation typo identification unit 133, an operation generation requesting unit 134, and a threshold obtaining unit 135. Each unit of the reproduction unit 130 implements the same functions as the units included in the reproduction 330 of the first embodiment.

Further, the recording/reproduction apparatus 100A of the second embodiment includes a storage unit 140. The storage unit 140 is a storage area provided in a memory or the like of the recording/reproduction apparatus 100A. In the recording/reproduction apparatus 100A of the second embodiment, the operation record information 200 recorded by the recording unit 120 may be stored in the storage unit 140. In this case, the reproduction unit 130 reproduces the operation record information 200 stored in the storage unit 140.

According to the second embodiment, the accuracy of replicating an operation can be maintained even in a case where, for example, the setting of the determination threshold of the recording/reproduction apparatus 100A is changed because the recording by the recording unit 120 and the reproduction by the reproduction unit 130 can be performed with a single computer. That is, according to the second embodiment, the accuracy of the replication of an operation can be maintained even in a case where the setting environment of a display screen during the recording of the contents of an operation and the setting environment of a display screen during the reproduction of the contents of the operation are different.

The case where the settings of the determination threshold is changed may be, for example, a case where different determination thresholds are set to the recording/reproduction apparatus 100A with respect to each user or a case where an administrator or the like of the recording/reproduction apparatus 100A changes the settings of the determination threshold of the recording/reproduction apparatus 100A.

### Third Embodiment

Next, the third embodiment of the present invention is described with reference to the accompanying drawings. The third embodiment is different from the first embodiment in that the operation record information 200 recorded by the recording apparatus 300 is stored in an external server.

Therefore, other than the difference between the first embodiment and the third embodiment, like functions (functional units) and components are denoted with like reference numerals of the first embodiment and are not further described.

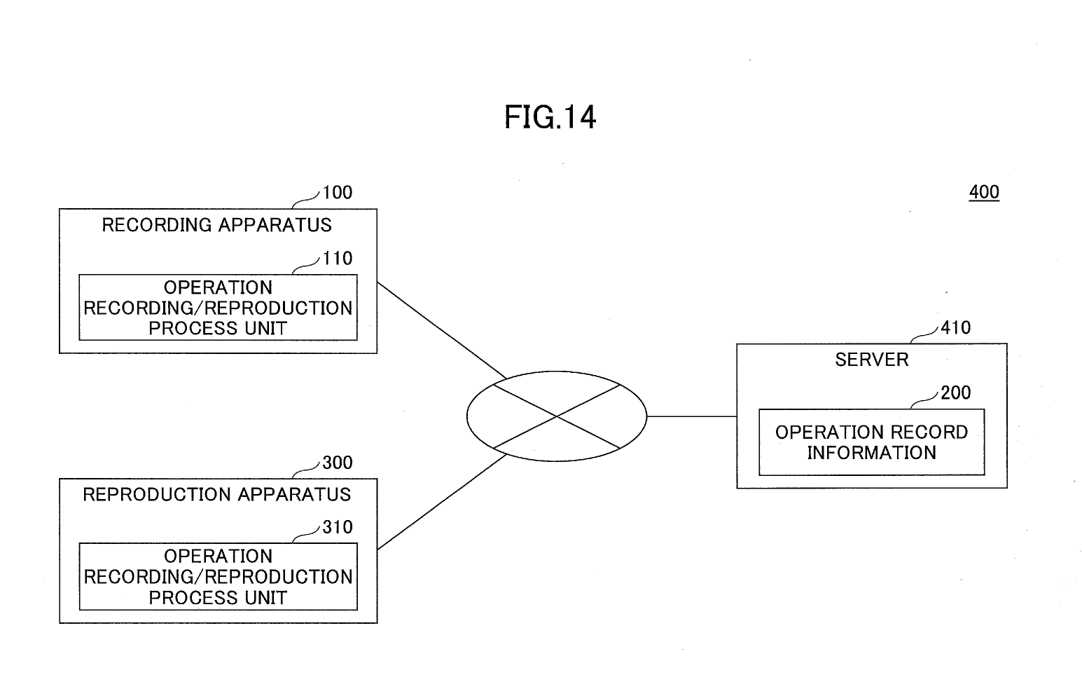

FIG. 14 is a schematic diagram of a system configuration of a recording/reproduction system 400 according to the third embodiment of the present invention. The recording/reproduction system 400 of the third embodiment includes the recording apparatus 100, the reproduction apparatus 300, and a server 410. The recording apparatus 100, the reproduction apparatus 300, and the server 410 are connected to each other via a network.

The recording apparatus 100 of the third embodiment uses the recording unit 120 of the operation record reproduction unit 110 to record the operation record information 200 in the server 410. The recording apparatus 100 of the third embodiment may transmits the recorded operation record information 200 to the server 410 when an instruction to terminate the recording of the contents of an operation is received.

The reproduction apparatus 300 of the third embodiment uses the reproduction unit 330 of the operation record reproduction unit 310 to read the operation record information 200 from the server 410 and reproduce the contents of the operation record information 200. The reproduction apparatus 300 of the third embodiment may reproduce the operation record information 200 retained in the reproduction apparatus 300 after obtaining all of the operation record information 200 from the server 410.

Hence, according to the third embodiment, the reproduction apparatus 300 need only to obtain the operation record information 200 from the server 400 and does not need to carry a portable-type recording medium recorded with the operation record information 200 or instructing the reproduction apparatus 300 to read out the operation record information 200 from the recording medium.

Thus, according to the above-described embodiments of the present invention, the accuracy of replicating an operation can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium on which a program is recorded for causing a processor to execute a process, the process comprising:
obtaining a first predetermined time that is sot to a first computer that records an operation;
comparing the first predetermined time with a time difference between a first clicking operation and a second clicking operation;
determining that a type of operation corresponding to the first and second clicking operations is a double-click operation when the time difference is shorter than the first predetermined time;
determining that the type of operation corresponding to the first and second clicking operations is a single-click operation when the time difference is longer than the first predetermined time;
recording operation record information corresponding to the operation;
obtaining a second predetermined time that is set to a second computer that reproduces the operation;
instructing that the second clicking operation be generated after the first clicking operation is instructed to be generated in a case where the type of the operation included in the operation record information is the double-click operation; and
instructing that the second clicking operation be generated when the second predetermined time elapses after the first clicking operation is instructed to be generated in a case where the type of the operation included in the operation record information is the single-click operation.

2. The non-transitory computer-readable recording medium as claimed in claim 1, wherein the operation record information includes
identification information that identifies a display component to be subjected to the operation, and
operation type information that indicates the type of operation performed on the display component.

3. A non-transitory computer-readable recording medium on which a program is recorded for causing a processor to execute a process, the process comprising:
obtaining a first predetermined time that is set to a first computer that records an operation;
detecting a first eliciting operation and a second clicking operation;
recording a type of the first and second clicking operations as a double-click operation when the second clicking operation is detected within the first predetermined time after the first clicking operation is detected;
recording the type of first and second clicking operations as a single-click operation when the second clicking operation is detected after the first predetermined time has elapsed after the first clicking operation is detected,
reading operation record information in which the type of the first and second clicking operations are recorded;
obtaining a second predetermined time that is set to a second computer that reproduces the operation;
instructing that the second clicking operation be generated after the first clicking operation is instructed to be generated in a case where the type of the operation included in the operation record information is the double-click operation; and
instructing that the second clicking operation be generated when the second predetermined time elapses after the first clicking operation is instructed to be generated in a case where the type of the operation included in the operation record information is the single-click operation.

4. A method for causing a processor to execute a process comprising:
obtaining a first predetermined time that is set to a first computer that records an operation;
comparing the first predetermined time with a time difference between a first clicking operation and a second clicking operation;
determining that a type of operation corresponding to the first and second clicking operations is a double-click operation when the time difference is shorter than the first predetermined time;
determining that the type of operation corresponding to the first and second clicking operations is a single-click operation when the time difference is longer than the first predetermined time;
recording operation record information corresponding to the operation;
obtaining a second predetermined time that is set to a second computer that reproduces the operation;
instructing that the second clicking operation be generated after the first clicking operation is instructed to be generated in a case where the type of the operation included in the operation record information is the double-click operation; and
instructing that the second clicking operation be generated when the second predetermined time elapses after the first clicking operation is instructed to be generated in a case where the type of the operation included in the operation record information is the single-click operation.

5. A system comprising:
a recording apparatus that records operation record information; and
a reproduction apparatus that reproduces the operation record information;
wherein the recording apparatus includes a processor that executes a process including
obtaining a first predetermined time that is set to a first computer that records an operation,
comparing the first predetermined time with a time difference between a first clicking operation and a second clicking operation,
determining that a type of operation corresponding to the first and second clicking operations is a double-click operation when the time difference is shorter than the first predetermined time,
determining that the type of operation corresponding to the first and second clicking operations is a single-click operation when the time difference is longer than the first predetermined time, and
recording the operation record information corresponding to the operation, and
wherein the reproduction apparatus includes a processor that executes a process including
obtaining a second predetermined time that is set to a second computer that reproduces the operation,
reading the operation record information from the recording apparatus,
instructing that the second clicking operation be generated within the second predetermined time after the first clicking operation is instructed to be generated in a case where the type of the operation included in the operation record information is the double-click operation, and
instructing that the second clicking operation be generated when the second predetermined time elapses after the first clicking operation is instructed to be generated in a case where the type of the operation included in the operation record information is a plurality of the single-click operations.

6. A non-transitory computer-readable recording medium on which a program is recorded for causing a processor to execute a process, the process comprising:
reading operation record information in which a type of the first and second clicking operations are recorded as a result of determining whether the first clicking operation and the second clicking operation subsequent to the first clicking operation correspond to a double-click operation or multiple clicking operations;
instructing that the second clicking operation be generated within the second predetermined time after the first clicking operation is instructed to be generated in a case where the type of the first and second clicking operations included in the operation record information corresponds to the double-click operation, and
instructing that the second clicking operation be generated when the second predetermined time elapses after the first clicking operation is instructed to be generated in a case where the type of the first and second clicking operations included in the operation record information correspond to the multiple clicking operations.

7. The non-transitory computer-readable recording medium as claimed in claim 6,
wherein the type of operation corresponding to the first and second clicking operations are recorded as the double-click operation when the second clicking operation is detected within a time different from the predetermined time after the first clicking operation is detected, and
wherein the type of operation corresponding to each of the first and second clicking operations is recorded as the single-click operation when the second clicking operation is detected after the different time elapses from the time of detecting the first clicking operation.
